(19) United States
(12) Patent Application Publication
(10) Pub. No.: US 2011/0086540 A1
(43) Pub. Date: Apr. 14, 2011

(54) Cable and connector identifying tags

(76) Inventor: Stephen Bierce, Houston, TX (US)

(21) Appl. No.: 12/587,526

(22) Filed: Oct. 8, 2009

(51) Int. Cl. H01R 3/00

(52) U.S. Cl. 439/491

(57) ABSTRACT

A connection-identifying tag for electronic connectors comprises a coupling portion and a tag portion. In one embodiment, the coupling portion of a tag is adapted to mate with either or both of the male and female connectors in a connection. The tag portion of a tag bears connection-identifying indicia for distinguishing one connection from another among a plurality of connections.

### FIELD OF THE INVENTION

This invention generally relates to cables and connectors for electronic equipment and the like, and more particularly relates to tags for identifying cables and their connections to electronic equipment.

### BACKGROUND OF THE INVENTION

Electronic device systems such as so-called home entertainment systems or home theater systems and the like frequently include one or more cables to interconnect various devices in the system. In a home entertainment system, for example, there may be a main receiver or amplifier that receives input signals from numerous sources—a DVD player, a television signal converter, a CD player, a BlueRay media player, a radio tuner, a video gaming system, and so on. The receiver will also have a plurality of outputs, for example, a video output, audio outputs, and so on.

A connection in an electronics system typically involves an output connector and an input connector, with a length of cable extending therebetween. The cable is usually equipped with its own connectors adapted to mate with the respective output and input connectors to effectuate the connection.

Although persons of ordinary skill in the art will appreciate that there are a great many different types and styles of wiring connectors, certain ones have come to predominate in certain applications, such as consumer electronics. Among these is the popular “RCA” style of connector, an industry standard that is widely used in consumer electronics for audio and video signals. A single (coaxial) RCA connection can carry one track of a two-track (stereo) audio signal, or one video signal; thus, to carry a video signal with a corresponding stereo soundtrack requires at least three RCA connections.

For a system incorporating many different program sources and a receiver/amplifier, the number of cables necessary to install the system can be nearly unmanageable. Neat and organized installation can become very challenging.

The complexity of the interconnecting cables in an electronics system is particularly problematic in instances where it is necessary to disconnect and/or remove one or more components from the system, such as for example, if it becomes necessary to relocate, rearrange, or expand the system. Multi-function integrated receivers/amplifiers/preamplifiers further heighten the complexity factor, since they often provide for multiple configuration possibilities, such that there may be multiple possible ways to “correctly” make up the interconnections.

### SUMMARY OF THE INVENTION

In view of the foregoing, the present invention is directed to a system of identifier tags for use with connections between electronic devices. In one embodiment of the invention, a set of tags is provided wherein each tag is adapted to mate with the male or female connector of a connection, or both the male and female connectors of a connection. In one embodiment, the identifier tags each comprise a coupling portion for mating with an electronic connector, and an identifier portion which bears identifying indicia to distinguish one tag from others. In use, the tags are mated with the respective connectors of a connection such that a connection can be made up, or reproduced after temporary disconnection.

### BRIEF DESCRIPTION OF THE DRAWINGS

The present invention is best understood with reference to the following detailed description of embodiments of the invention, when read in conjunction with the accompanying drawings, in which like numerals refer to like elements, and in which:

FIG. 1 illustrates a plurality of connections to an electronic device such as a home electronics device;

FIG. 2a is a perspective view of a male RCA connector;

FIG. 2b is a perspective view of the connector of FIG. 2a mated with an identifier tag in accordance with one embodiment of the invention;

FIG. 3a is a perspective view of a female RCA connector;

FIG. 3b is a perspective view of the connector of FIG. 3a mated with an identifier tag in accordance with one embodiment of the invention;

FIG. 4a is a perspective view of an identifier tag for a male RCA connector in accordance with one embodiment of the invention;

FIG. 4b is a perspective view of an identifier tag for a female RCA connector in accordance with one embodiment of the invention; and

FIG. 5 is a perspective view of an identifier tag for both male and female RCA connectors in accordance with one embodiment of the invention.

### DETAILED DESCRIPTION OF SPECIFIC EMBODIMENTS OF THE INVENTION

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system and technical constraints), which will vary from one implementation to another. Moreover, attention will necessarily be paid to proper engineering practices for the environment in question. It will be appreciated that such development efforts might be complex and time-consuming, outside the knowledge base of typical laymen, but would nevertheless be a routine undertaking for those of ordinary skill in the relevant fields.

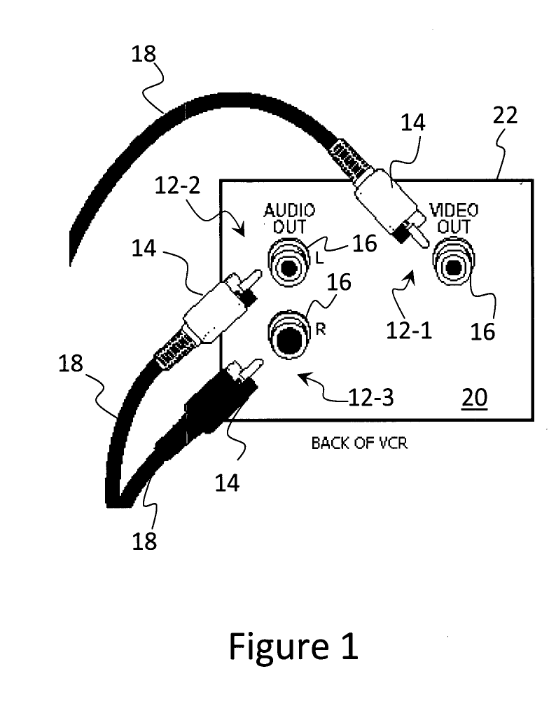

Referring to FIG. 1, there are shown a plurality of connections 12-1, 12-2, and 12-3 (collectively, connections 12) such as would be typically found on the back of a consumer electronics device, such as a DVD player or the like. As shown in FIG. 1, each connection 12 comprises a male connector 14 and a female connector 16. Connectors 14 and 16 in FIG. 1 are of the well-known “RCA” type, although persons of ordinary skill in the art having the benefit of the present disclosure will recognize that the invention is in no sense limited to applications involving this particular type of connector and will readily appreciate how the invention may be implemented for other types of connections, particularly connections employing a male connector and a female connector.

As shown in FIG. 1, each male connector 14 is disposed on the end of a cable 18, and each female connector 16 projects out of the housing 20 of a consumer electronics device 22.

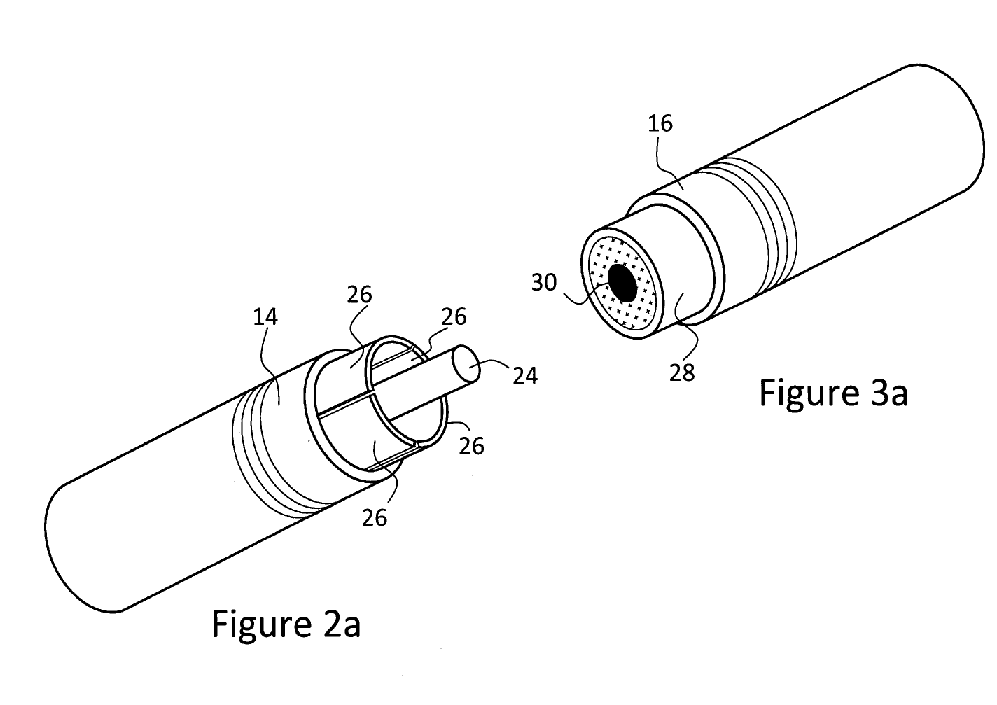

Referring to FIG. 2a, there is shown a single male RCA connector 14. In accordance with industry standard, connector 14 comprises an inner pin contact 24 and a plurality of “leaf” contacts 26 coaxially arranged around pin contact 24.

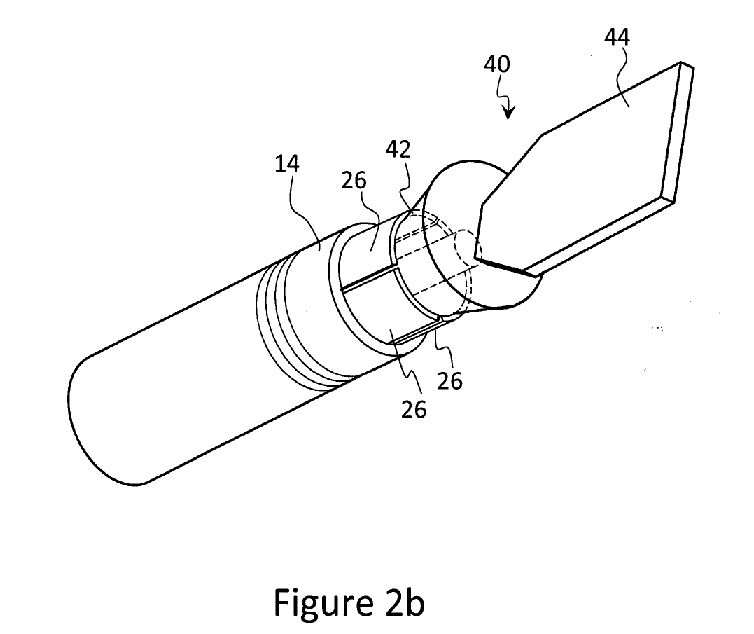

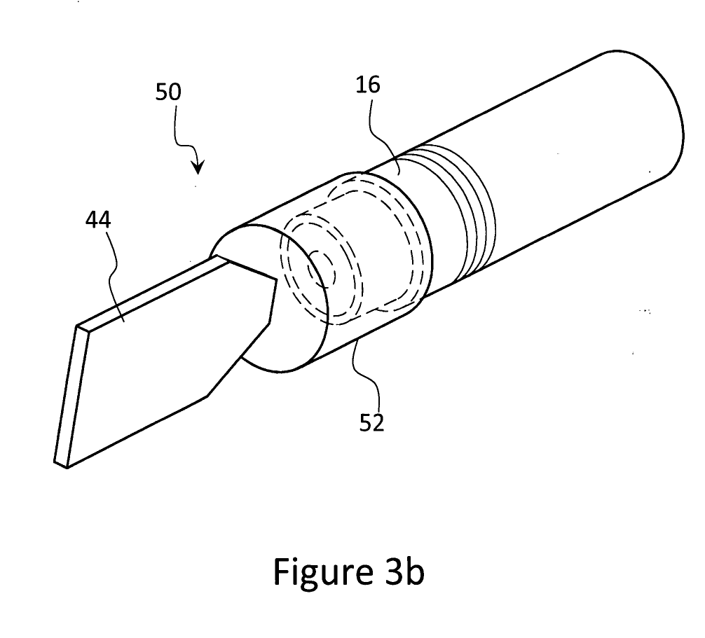

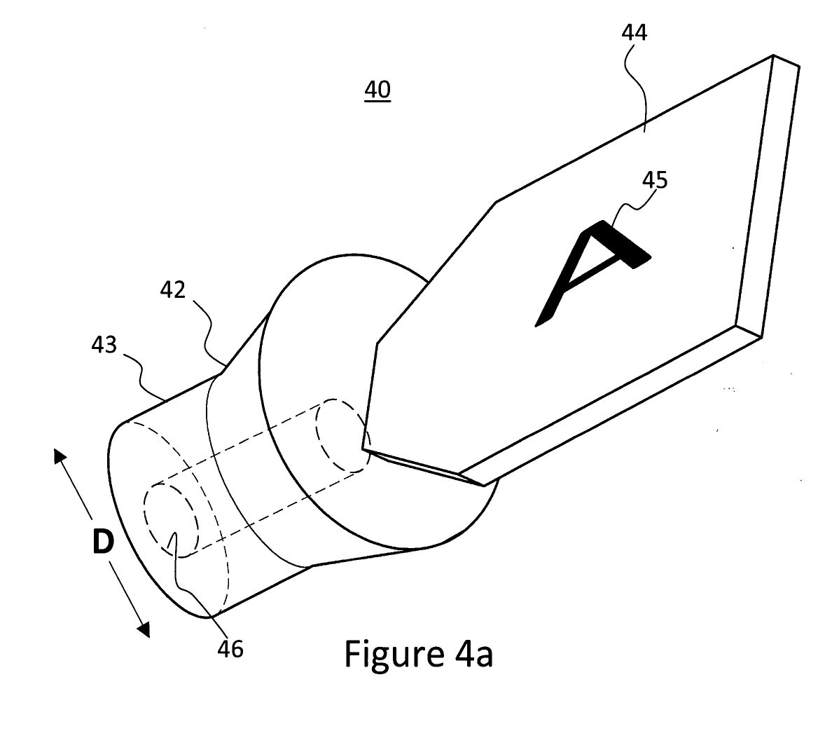

In FIG. 3a, there is shown a single female RCA connector 16. Also in accordance with industry standard, female RCA connector 16 comprises a “ring” contact 28 and an internal spring contact (not visible in FIG. 3a) disposed within a socket 30 at the front of connector 16. As would be familiar to those of ordinary skill in the art, when a male RCA connector 14 and a female RCA connector 16 are engaged with one another to “make up” a connection 12, the leaf contacts 26 of the male connector 14 engage the ring contact 28 of the female connector 16, and the pin contact 24 of the male connector 14 is partially inserted into socket 30 of female connector 16 to put pin contact 24 in electrical connection with the internal spring contact of the female connector 16. In this way, two separate electrical connections are made by each connector 14, as is commonly known.

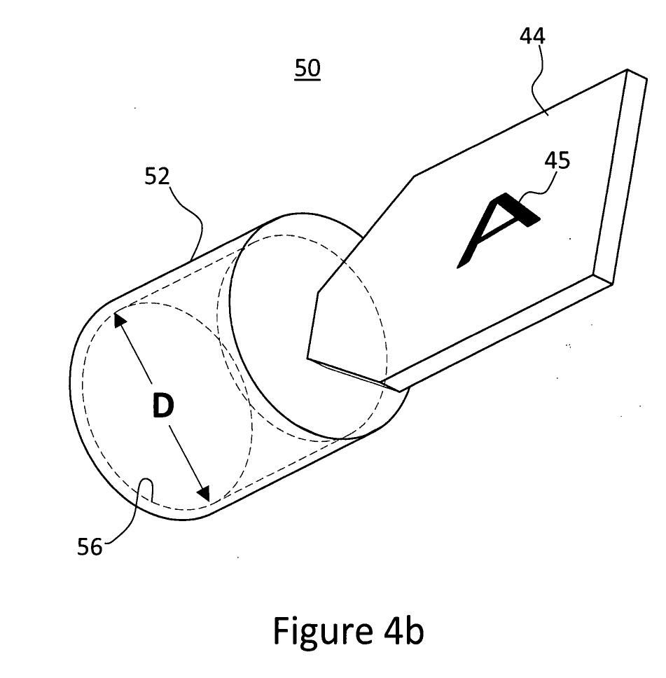

Turning now to FIG. 4a, there is shown a perspective view of a connection-identifying connector tag 40 in accordance with one embodiment of the invention. As shown in FIG. 4, tag 40 comprises a coupling portion 42 and an indicator portion 44. In a preferred embodiment, tag 40 is of unitary construction and may advantageously be manufactured using conventional means and materials, for example, by injection molding of plastic or the like.

In one embodiment of the invention, the lower portion 43 of the mating portion 42 of tag 40 has an outer diameter D (as represented in FIG. 4a) that is substantially the same as the outer diameter of the ring contact 28 of a female RCA connector 16 (see FIG. 3a). Further, tag 40 has a partial axial hole 46 adapted to receive the pin contact 24 from a male RCA connector 14. With this configuration, tag 40 is capable of mating with a male RCA connector 14, with the base portion of coupling portion adapted to fit within leaf contacts 26 of the male RCA connector, with the connector's pin 24 extending into hole 46 in tag 40. FIG. 2b shows tag 40 from FIG. 4a fitted onto the male RCA connector 14 from FIG. 2a. Tag 40 is retained on connector 14 by the frictional or spring force of leaf contacts 26 against coupling portion 42 of tag 40.

As shown in FIG. 4a, indicator portion 44 of tag 40 preferable has a symbol or other identifying indicia 45 thereon to distinguish one tag 40 from another. As used herein, “identifying indicia” shall include symbols, letters, numbers, icons, colors, holes or perforations, or combinations of these features, that serve to identify one tag 40 among a plurality of otherwise identical tags that might all be used in connection with a wiring or cabling operation, such as setting up a home entertainment system or the like.

In practice, a plurality of tags 40 may be provided to a user, with each tag 40 bearing unique identifying indicia 45 (for example, successive letters of the alphabet). In use, the indicia 45 can be used to designate a particular connector, and, as will be described below, to establish a correspondence between two (or more) connectors, such as the male and female connectors (14 and 16) of a given connection 12.

The reference numeral 44 shall be used to denote the indicator portion of various connection-identifying tags described in the present disclosure, even where the coupling portions of the various tags may vary depending upon the connector type or gender. Likewise, the reference numeral 45 shall be used to denote the indicia that each tag bears on its indicator portion 44, regardless of the configuration of the coupling portion of the tags in question.

Turning now to FIG. 4b, there is shown a connection-identifying tag 50 in accordance with another embodiment of the invention, and in particular, a tag adapted to engage the female connector 16 of an RCA connection 12. As shown in FIG. 4b, the mating portion 52 of tag 50 has a substantially hollow cylindrical configuration thereby having a cylindrical inner wall 56 of diameter D. In accordance with one aspect of the invention, the configuration of mating portion 52 is such that tag 50 may be mated with a female RCA connector 16, with the inner wall 56 surrounding and contacting the ring contact 26 of a connector 16. Note that no pin-like structure need be provided within tag 50, since tag 50 is not required to make any electrical contact.

FIG. 3b shows tag 50 installed on a female RCA connector 16 in accordance with the disclosed embodiment of the invention.

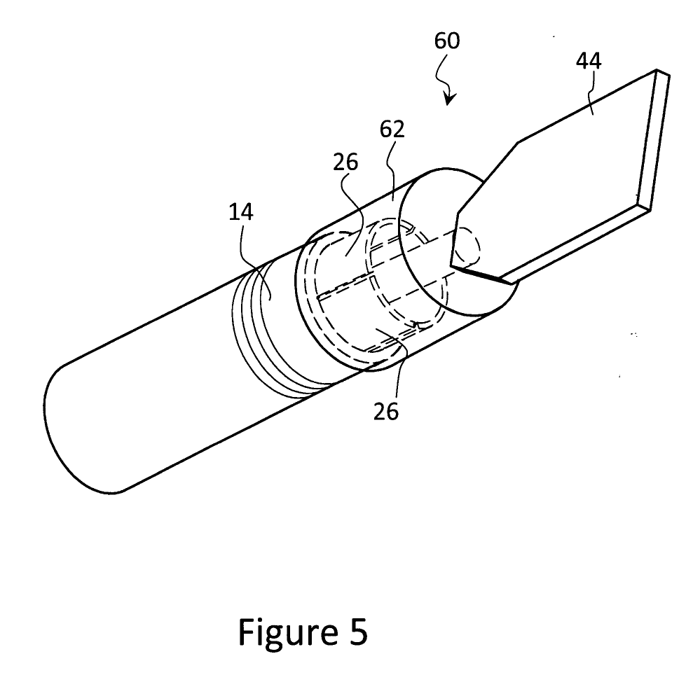

Turning to FIG. 5, there is shown a perspective view of an alternative embodiment of the invention, namely a connection-identifying tag 60 adapted to engage a male RCA connector 14 in a manner different than that of tag 40 shown in FIG. 4a. In particular, tag 60 shown in FIG. 5 is adapted to engage male RCA connector 14 by surrounding leaf contacts 26 in the same manner that connector 50 of FIG. 4b surrounds the ring contact 28 of a female RCA connector 16. As such, connector 60 has a substantially similar configuration to that of connector 50, namely, a substantially hollow cylindrical coupling portion 64 with an inner diameter D suited for insertion of the leaf contacts of a male RCA connector 14.

In accordance with one embodiment of the invention, it is contemplated that given the appropriate combination of internal diameter D and the tag 60 being made of an appropriately pliant material, one tag 60 may be used to engage either a male RCA connector 14 or a female RCA connector 16.

In one embodiment pairs of tags including one tag 40 and one tag 50, or one tag 60 and one tag 50, or two tags 60, are provided to the user, with each pair of tags bearing common identifying indicia. For example, a collection of tags may be packaged together including a plurality of tags 40 and a plurality of tags of type 50, where each tag 40 (for male RCA connectors 14) is paired with a corresponding tag 50 (for female RCA connectors), with each pair of tags 40/50 bearing common differentiating indicia. With such a package, a plurality of connections (each including a male connector and a female connector) can be uniquely identified.

From the foregoing disclosure, it should be apparent that identifying tags for identifying cables and their connections to electronic equipment and the like has been disclosed.

Although specific embodiments of the invention as well as possible variants and alternatives thereof have been described and/or suggested herein, it is to be understood that the present disclosure is intended to teach, suggest, and illustrate various features and aspects of the invention, but is not intended to be limiting with respect to the scope of the invention, as defined exclusively in and by the claims, which follow.

Indeed, it is contemplated and to be explicitly understood that various substitutions, alterations, and/or modifications, including but not limited to any such implementation variants and options as may have been specifically noted or suggested herein, may be made to the disclosed embodiment of the invention without necessarily departing from the technical and legal scope of the invention as defined in the following claims. In particular, it is contemplated that the present invention may be applied in connection with connectors of types other than the RCA connectors featured in the present disclosure.

What is claimed is:

1. A set of identifier tags for connections to and between electronic devices, comprising:
a first tag, adapted to mate with a male connector of a first connection;
a second tag, adapted to mate with a female connector of said first connection;
wherein said first and second tags bear a first common identifier distinguishing said first connection from at least one other connection among said plurality of connections.

2. An identifier tag set in accordance with claim 1, wherein said common identifier consists of a letter, a number, a word, a symbol, a color, a perforation, an adhesive label, or combination thereof.

3. An identifier tag set in accordance with claim 1, further comprising:
a third tag, adapted to mate with a male connector of a second connection;
a fourth tag, adapted to mate with a female connector of said second connection;
wherein said third and fourth tags bear a second common identifier distinguishing said second connection from at least one other connection among said plurality of connections.

4. An identifier tag set in accordance with claim 3, wherein said first and second common identifiers are substantially the same.

5. An identifier tag set in accordance with claim 1, wherein said male connector and said female connector are RCA connectors.

6. An identifier tag set in accordance with claim 2, wherein said first and second common identifiers are applied by a user upon use of the identifier tag set.
